(19) United States
(12) Patent Application Publication
(10) Pub. No.: US 2024/0419883 A1
(43) Pub. Date: Dec. 19, 2024

(54) THERMAL CONDUCTIVITY IN INTEGRATED CIRCUITS

(71) Applicant: Intel Corporation, Santa Clara, CA (US)

(72) Inventors: Lei JIANG, Camas, WA (US); Daniel CHRISTENSEN, Portland, OR (US); Daniel PANTUSO, Portland, OR (US); Kambiz KOMEYLI, Portland, OR (US); Jeffrey HICKS, Banks, OR (US); Manjunath SHAMANNA, Austin, TX (US)

(21) Appl. No.: 18/209,434

(22) Filed: Jun. 13, 2023

(51) Int. Cl. G06F 30/392; G06F 30/394

(52) U.S. Cl. CPC G06F 30/392; G06F 30/394; G06F 2119/08

(57) ABSTRACT

Disclosed is an integrated circuit with a metallization stack that has thermal tower assemblages formed from wires in two or more metal layers to assist in dissipating heat out of the metallization stack.

### TECHNICAL FIELD

Embodiments of the invention relate to the field of integrated circuit manufacturing and more specifically, to metallization stack structures for dissipating heat, as well as to methods for making the same.

### BRIEF DESCRIPTION OF THE DRAWINGS

FIG. 1 is a side schematic view of a conventional metallization stack section in an integrated circuit.

FIG. 2 is a side schematic view of an integrated circuit having a backside power delivery network.

FIG. 3 is a side schematic view of an integrated circuit having a frontside metallization stack with thermal towers in accordance with some embodiments.

FIG. 4 is a schematic side view of an IC portion highlighting exemplary thermal tower configurations in accordance with some embodiments.

FIGS. 5A-5D are schematic top and side views of thermal tower implementations in metallization layers in accordance with some embodiments.

FIG. 6 shows an exemplary EDA design flow including a routine for incorporating thermal towers into a metallization stack in accordance with some embodiments.

FIG. 7 is a flow diagram illustrating a thermal fill routine in accordance with some embodiments.

FIG. 8 is a block diagram showing a computing system that may be used for running APR and thermal fill tools in accordance with some embodiments.

### DETAILED DESCRIPTION

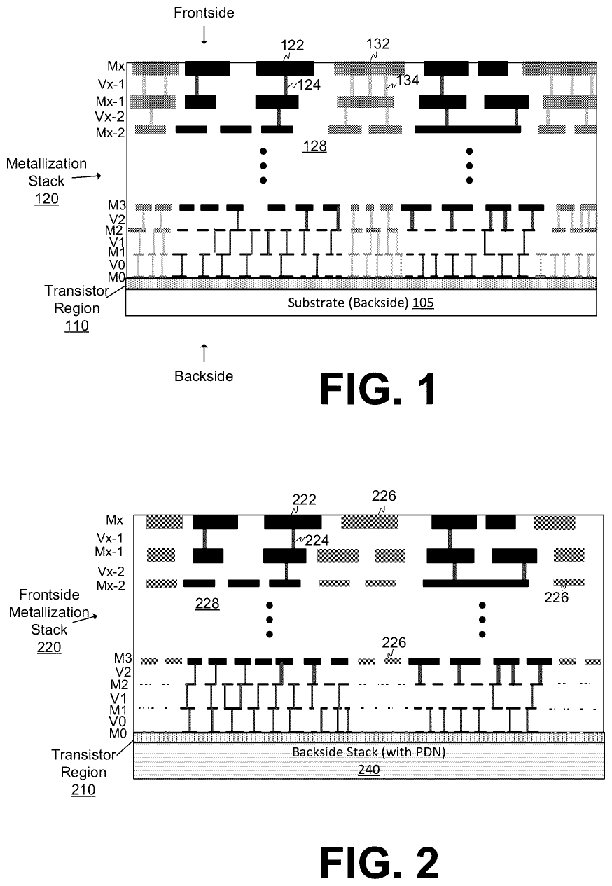

FIG. 1 shows a simplified side view of a conventional metallization stack section 120 in an integrated circuit. The IC includes a transistor layer 110, which is disposed between substrate 105 and a frontside metallization stack 120. The metallization stack 120 is built up as a series of metal layers (M0 through Mx) electrically coupled together through via layers (V0 through Vx), which are interleaved between the metal layers. The number of layers can vary, depending on IC complexity. For example, some advanced devices can have 13 or more layers.

The metallization layers include wires (also referred to as traces or metal sections) of both signal wires 122 and power supply wires 132, coupled respectively through the stack by way of signal vias 124 and power supply vias 134. The metal layers (M0-Mx) are separated with inter metal layers (IML) of a dielectric material 128. The dielectric material electrically insulates the various signal and power lines from each other and also ideally provides at least some structural stability for the metallization stack assembly. The metal stack 120 also typically includes floating metal “fill” pieces (not shown) that are added to otherwise insufficiently occupied areas in order to satisfy DFM (design for manufacturing) metallization density requirements.

The signal wires together with their particularly connected vias may be referred to as signal lines. Likewise, the power supply wires together with their particularly connected vias may be referred to as power lines. Together, the signal and power lines provide electrical connections between cell nodes within the IC itself, as well as between the IC and external package devices.

(Note that it is common for the metal wires in each layer to be disposed within spaced apart “track” locations. In many cases, the tracks from one layer to an adjacent layer will be perpendicularly oriented, forming a grid of overlaying tracks between adjacent layers, although this is not always the case. In other instances, adjacent layers may have tracks aligned in parallel (or some other relationship) to each other, and the tracks in the different layers may or may not wholly or partially overlap one another. With such a three-dimensional “grid” network of metal track positions, an enormous variety and quantity of signal and power line configurations can be attained with strategically placed vias connecting specific tracks at specific locations. This is why the cross-sectional view of FIG. 1 shows wire sections (122, 132) with or without connected vias and also having different lengths. Apart possibly from ground and power sections, any given track typically is occupied with many different wire sections spaced sufficiently away from each other to maintain signal integrity.)

As indicated in the figure (not to scale), the metal wires and vias are typically larger at the higher layers with larger spaces between them. With particular relevance to the power lines, since supply currents coming from the package must traverse all of these layers through metal lines that get increasingly narrow (and thus, more resistive) as they approach the transistor layer, they lose energy, resulting in power delivery (or IR drop) losses. Another problem is that the power lines take up a lot of space in the metallization stack, making it more challenging to accommodate all of the required signal line connections. Accordingly, chip makers are turning to a different approach whereby the power lines are removed from the front-side stack and instead provided to the transistors through the chip's backside.

FIG. 2 shows a simplified view of an IC with backside power delivery. Here, the backside includes a substrate 240 with a backside power delivery network. As is exaggeratedly shown in this figure, with the removal of power lines from the front-side stack, there is additional space available for more and/or different signal line configurations formed from signal wires 222 and signal vias 224, but unused space may remain, nonetheless. Accordingly, additional metal fill traces 226 may be used to satisfy DFM requirements.

While the use of backside power delivery can substantially improve power delivery, along with frontside signal connectivity for that matter, there may be new thermal management challenges for several different reasons. First, the power lines (wires and vias) that used to reside in the frontside stack along with the signal lines, result in high density metal lines, which naturally promotes good heat spreading properties. They convey much of the heat away from the transistor layer because the preferred dielectric materials, which have favorable low K properties, typically also have very poor thermal conductivity properties. The use of added metal fill traces, alone, does not adequately make up for the missing power lines because, among other reasons, they are not connected to each other through the various layers as would be the case with power wires and vias.

Moreover, in some configurations, in order to facilitate power connectivity to the transistors from the backside, different assembly types are used that result in the transistor layer being farther away or otherwise more thermally isolated from the assembly heatsink, which is typically made part of the frontside structure. The frontside structure and bonding layers may limit the thermal spreading that otherwise can exist when the transistors are in more direct contact with frontside bulk silicon. This is especially problematic with advanced transistor types such as FinFETs and gate-all-around (GAA) transistors, which can generate very high-power density regions because of the number of devices that can fit within a given cell area. Accordingly, some embodiments address these challenges by providing solutions that may incorporate thermal conducting elements (also referred to as towers in this disclosure) into the frontside metal stack.

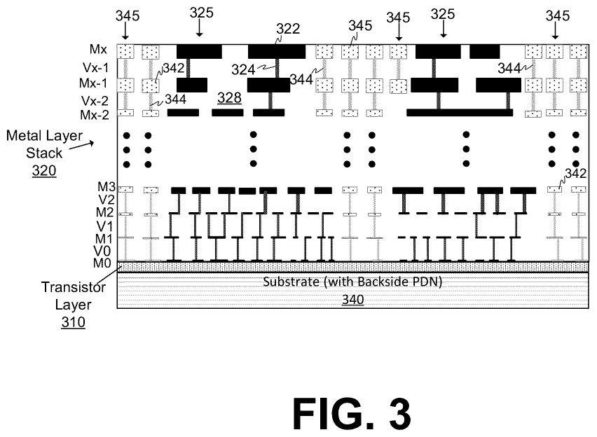

FIG. 3 is a side schematic view of an IC having thermal towers incorporated into a frontside metallization stack. The IC has a backside substrate 340 that includes a power delivery network (PDN), a frontside metal layer stack 320 and a transistor region 310 sandwiched there between. The backside power delivery stack may be implemented with any suitable backside power delivery methodology where power lines are applied to the transistors from one side and signal lines are provided from the other side. For example, suitable schemes could include but are not limited to Intel Corp. PowerVia™ or IMEC Intl. Buried Power Rail™ backside Power Delivery solutions.

The frontside stack 320 includes multiple metal layers (M0 through Mx) and via layers (V0 through Vx) interleaved between the metal layers. These metal and via layers are used to form signal lines from wire sections 322 and vias 324. In some embodiments, they are also used to form via ladders (or thermal towers) 345 from wire sections 342 and vias 344. The thermal towers 345 may be designed using automated design methods discussed later in this disclosure. For example, through dynamic design of the tower structures after the signal lines have been defined, they can efficiently be configured to take advantage of available remaining stack space to achieve improved heat transfer without materially affecting the design process or signal line performance. For example, cross capacitance penalties can be reduced by strategically deploying denser tower coverage in higher power consuming areas while keeping them sufficiently away from sensitive signal activity areas. While for simplicity, in the figure, they are shown as being relatively long and of the same configuration, thermal tower assemblages may be of different sizes (both in length and area), different pattern configurations and have different spacings from each other and from neighboring signal lines. The figure shows them extending from the top to the bottom of the stack but in reality, many if not most towers will be made of relatively short assemblages, perhaps being formed from 2 to 5 adjacent metal layer wire sections, although this of course will depend on available space in the stack and specific design considerations.

It should be appreciated that any suitable materials may be used to implement the wires, vias and dielectric materials. For example, the wires and vias could be formed using cobalt, copper, aluminum, tungsten, ruthenium, nickel, alloys of the same, and/or combinations of the same. Moreover, different metal materials may be used for different metal and/or via layers. For example, cobalt or ruthenium may be used for local metal layers (those closest to the transistors) where feature dimensions can be much smaller than those for the upper layers, which could employ other metal materials such as copper. Cobalt and ruthenium can work well in the local layers because both materials have less resistance degradation at smaller dimensions and are more robust to migration effects, compared to copper.

In addition, any suitable configurations may be used to implement the vias for both signal lines and tower assemblages. For example, different via types such as double, bar (rectangular), single, and other types could be employed. In addition, as with the metal wires, electromigration constraints may affect materials and process methods used for making the vias, and they may or may not be implemented differently for the various different via layers.

Likewise, any suitable material or material combination may be used for the inter metal layers. Low-k dielectric materials are typically used to limit electronic crosstalk, charge build-up, and signal propagation delay. Some examples of low-k materials include fluorine-doped silicon dioxide, organo-silicate glass (carbon-doped oxide), and porous silicon dioxide to mention just a few suitable materials for certain design implementations.

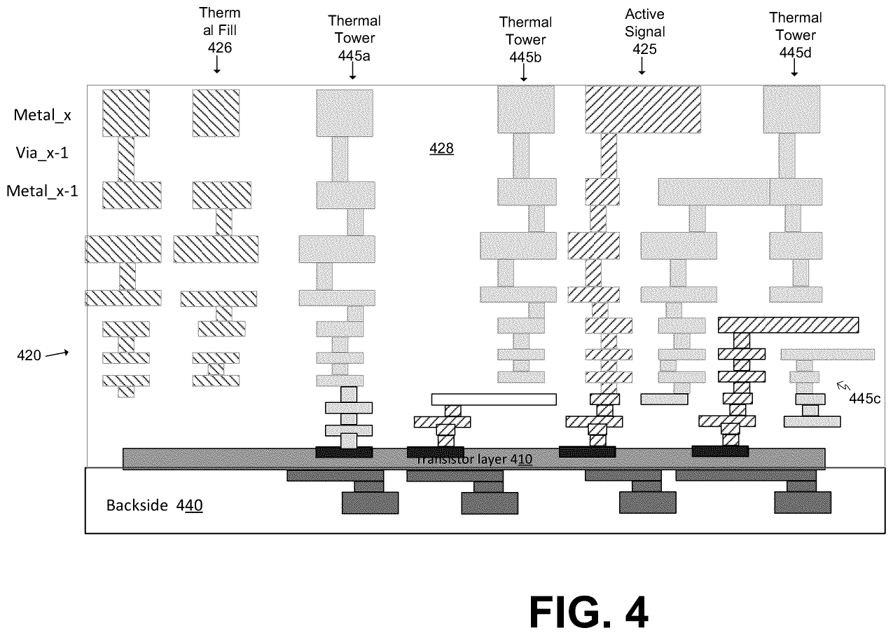

FIG. 4 is another schematic side view of an IC portion highlighting exemplary thermal tower configurations in accordance with some embodiments. The IC includes a transistor layer 410 disposed between frontside section 420 and backside section 440, which includes a power delivery network. The frontside stack includes signal lines 425 and thermal towers 445, along with metal fill sections 426, disposed within a dielectric material 428.

In this figure, different types of tower configurations are illustrated. Tower 445a is a relatively long tower assemblage, extending from the top of the metal stack all the way down to the transistor level 410 and/or in some cases, to the backside metal layer assembly 440. In some embodiments, as is indicated here, towers can be coupled through contacts (e.g., gates, source/drain contacts, etc.) to areas of the transistor region that wouldn't adversely affect circuit operations in order to facilitate better thermal conductivity through the thermal towers. For example, dummy transistors could be patterned and coupled to thermal towers through such contacts, or the contacts could be placed on unused areas of the active transistor material. It should be appreciated, however, that coupling to the transistor layer, whether or not to dummy transistors, can occur with any sized tower assemblages and tower assemblages may be coupled with backside assemblies without necessarily being coupled to transistors.

Tower assemblage 445b extends downward but only until it reaches a signal wire section. Tower assemblage 445c is an example of how a tower does not have to extend from above the transistors level. As seen here, towers may be implemented in any two adjacent metal layers, even if they are lower in the metal stack. Finally, tower assemblage 445d illustrates yet another type of configuration. Here, the assemblage is composed of wires in two separate tracks, making it laterally wider than the other presented towers. With this example in mind, tower assemblages may have any suitable area (as seen from above or below the transistor layer) as may be dictated by a particular region within the stack. On one hand, wider tower assemblages may create greater cross capacitance parasitics, but on the other hand, this may be tolerable if the increased area serves to provide sufficiently enhanced heat transfer, especially, for example, away from a known hot region.

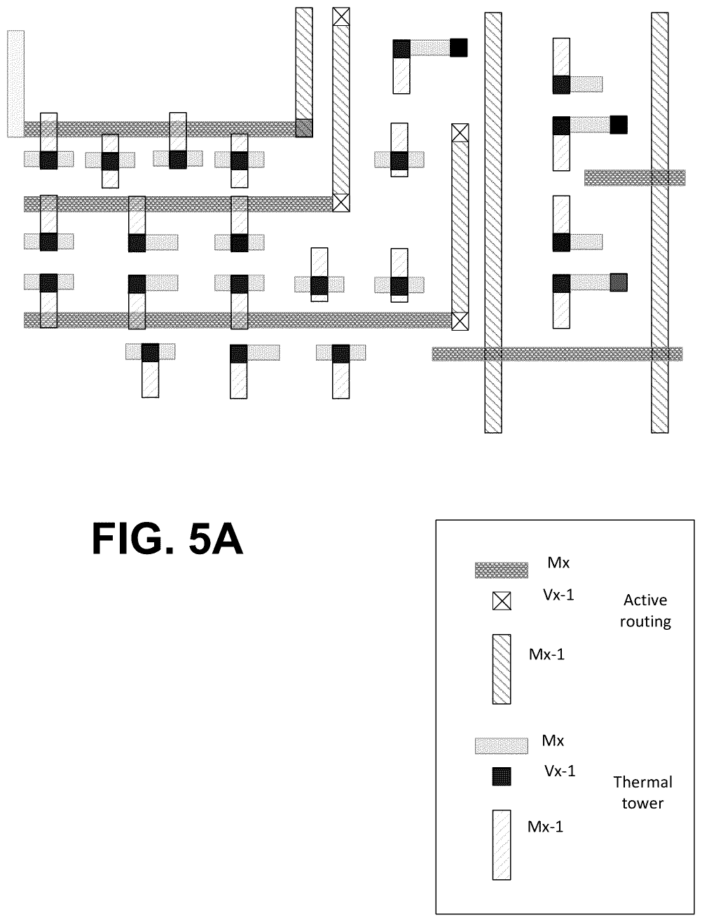

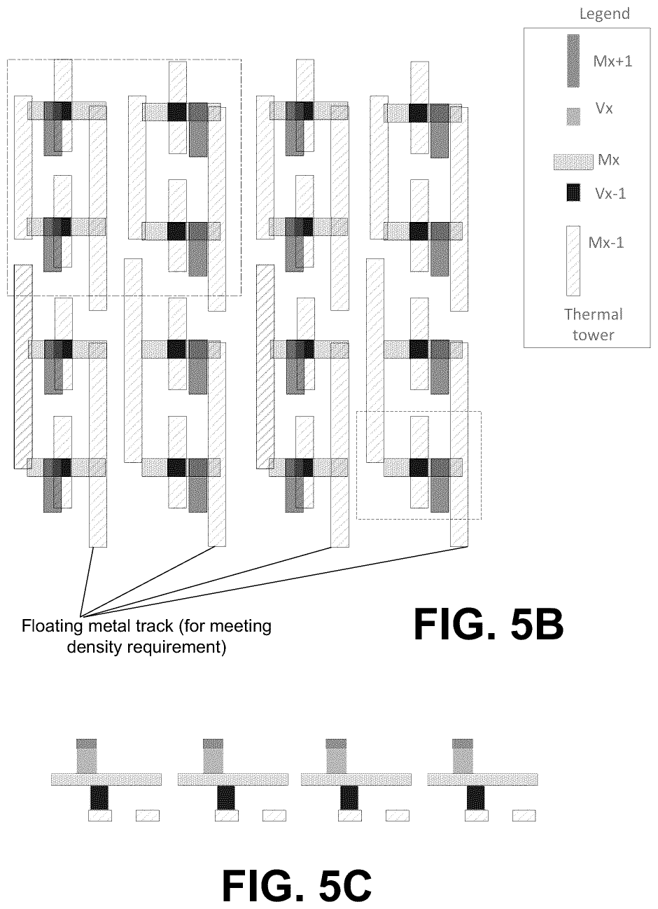

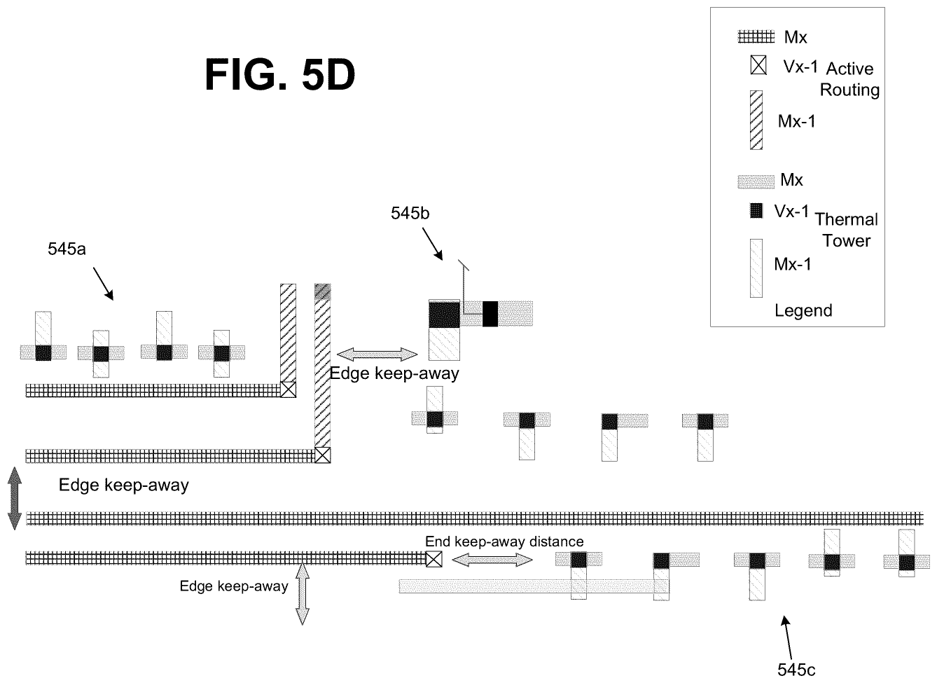

FIGS. 5A through 5D show schematic top and side views of different tower assemblage configurations, sizes, spacings, and approaches, in accordance with some embodiments. FIG. 5A illustrates exemplary tower sections for at least two adjacent metal layers (Mx, Mx-1). Here, the Mx and Mx-1 layers have perpendicularly aligned tracks. The towers are implemented with connecting vias (in the Vx-1 layer) where there are open wire sections (not connected to active signals) and where these open sections are sufficiently away from active signal trace sections.

FIGS. 5B and 5C illustrate how tower assemblages may be implemented in relatively open regions, which don't have active signal line structures. FIG. 5B is a top view of a group of two-level towers, while FIG. 5C is a side view of the towers of FIG. 5B from an upward looking perspective. (For clarity in illustration, only two tower levels are shown, but some or all of these towers could include additional segments below or above the depicted layers. When available, such arrays of redundant tower routings provide a consistent fabric of objects with predictable metal and via density, reducing manufacturing variations.

FIG. 5D is a top schematic diagram showing additional tower configuration examples. Tower assemblages 545a and 545c are placed up to a designated restricted region, due, for example, to especially sensitive active signal wires, as shown. Tower assemblage 545b is an example of a tower structure having a relatively larger area. In this case, it achieves a larger area using wider tower wires. How tower wires are configured, of course, for a particular tower structure will likely be constrained by particular placement and routing rules, e.g., wire track sizes, allowable locations, relative distance from each other, and the like.

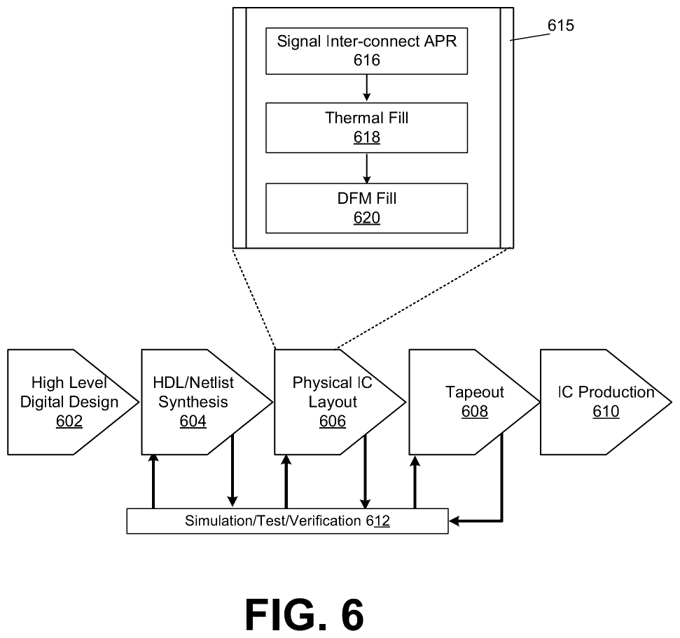

FIG. 6 is a diagram illustrating at a high level a design flow for an integrated circuit (IC) in accordance with some embodiments. It generally begins with a high-level functional design 602. This involves defining functional operation, at system and sub-system levels, along with other parameters such as operational performance, resource constraints, and reliability.

Next is an HDL (hardware description language) and netlist stage at 604. This involves translating the digital blocks with behavior descriptions developed in the early design phase 602 into an HDL format such as Verilog or VHDL. This phase is often called the Register Transfer language (RTL) phase, which generally includes functional verification to ensure that the logic implementations meet specification parameters at a high-level. After this step, the hardware description is then converted into a gate-level netlist, during which a variety of implementations and optimization routines may be tried to better meet design goals. Important considerations at this stage include power budget, speed, footprint, and reliability.

Next, at 606, physical IC layout typically occurs. Here, gate-level netlists are transformed into physical layouts, which are geometric representations of the layers and physical structures of the integrated circuit. Floor-planning methods are employed to ensure placement of the blocks and pads throughout the IC meet design goals. Due to the structured and repetitive nature of some digital blocks, such as memory and registers, portions of digital IC layout are often done using scripts and automated software processes (e.g., so-called automated placement and routing, APR). External and internal IP blocks may also be placed during this stage, where the necessary interface portions of the IP are revealed by the software. Typically, after blocks and gates are positioned, along with manual routing if necessary, routing automation scripts are then used to connect the various different elements through the interconnect structure that is to be employed.

With particular relevance to this disclosure, the physical layout stage 606 may include a process 615 for incorporating thermal towers into a metallization stack. At 616, a signal interconnect APR tool may be used to place and route interconnect signal lines to connect the various IC circuit elements to be connected. (Note that power lines for the backside stack may or may not be placed and routed with the APR tool here. For purposes of this disclosure, the routine is focused on APR for the frontside stack.) Along with synthesized netlist data, the APR tool may also use schematics and/or HDL data to place and route the signal interconnect features. In some embodiments, the signal interconnect APR may generate a data structure (e.g., array) containing data corresponding to the signal routing connections (e.g., signal via and wire locations) for each layer.

At 618, a thermal fill routine is then executed. This routine uses the signal interconnect data structure to examine the various frontside layers to identify and configure suitable thermal tower assemblages based on various criteria and design rules. When this is done, a DFM routine 620 may then be executed to add features, such as floating fill pieces, to satisfy any remaining DFM requirements.

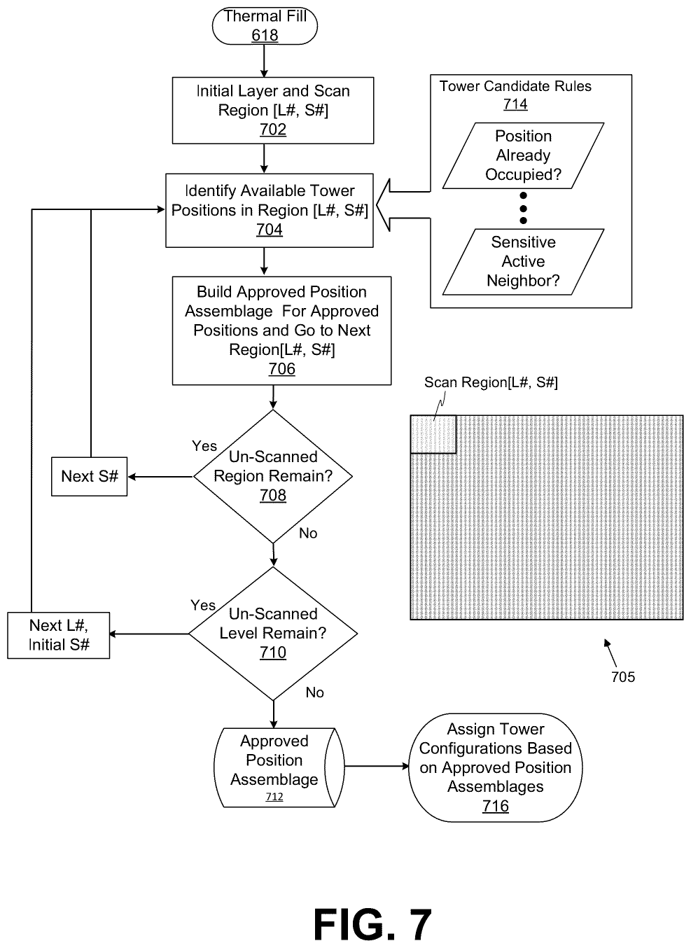

In this way, the thermal fill routine can be implemented as an add-on or incorporated within already used APR tools and thus, there is an opportunity for minimal impact on signal routing efficiency. One example of an approach for implementing a thermal fill routine 618 is illustrated in FIG. 7.

Returning back to the overall design flow, at 608, the design is ready for tapeout. Verification and simulation are performed, both of which taking into account the placement and physical features of the layout. If successful, the result is an output file, such as GDSII (Graphic Design System II) format, which a foundry can then use to fabricate the IC for the tape-out stage. Usually, the foundry will discover issues with the design that then need to be corrected by the design team. After tape-out, a small batch of first-run or prototype ICs are typically produced so that testing can be performed. This testing may result in redesign or process changes depending on the performance and economics of producing the IC. Once test results are satisfactory, the IC can then go into mass production as represented at 610.

Note that as shown at 112, along and within each of these design stages, simulation, verification, testing, and re-design (SVTR) can, and normally will, occur. In fact, overall design flows are greatly improved with enhanced SVTR processes, especially when they are performed well in the earlier design stages.

FIG. 7 is a flow diagram showing an example of a thermal fill process in accordance with some embodiments. The signal interconnect APR from 616 may generate a data structure (e.g., array) containing data corresponding to the signal routing connections (e.g., signal via and wire locations) for each layer. The thermal fill routine 618 may then use this signal interconnect data to generate the various thermal towers. In some embodiments, it processes the data by dividing each layer into constituent scan regions and then scanning each region, one at a time, until a layer has been scanned and then it goes on to a next layer to scan all of its regions, and so on, until all necessary regions and layers have been scanned. A conceptual layer for scanning, along with a rectangular scanning region, is shown at 705. In order to achieve adequate coverage, a scanning window on the order, for example, of 500 nm by 500 nm may be used, although any suitable scanning window size may be used and also may be adjustable.

At 702, the routine sets an initial level and region [L #, S #] to be scanned. From here, it goes to 704 and identifies available positions within the region for tower feature placement. Any suitable scheme could be used for analyzing the signal interconnect data structure, depending on how the signal interconnect elements are represented. For example, they could be represented with pixel values or alternatively, with vector values for pre-defined shapes with size parameters, etc.

Regardless of how the data is processed, the routine may use various rules 714 to decide if positions within the region are approved candidates for tower features. For example, a position would likely be disapproved if it is occupied by or too close to a signal interconnect feature. In addition, in some embodiments, a routine may treat layers differently depending on where they are in the stack. for lower layers with small min spaces, the routine could choose to fully avoid any adjacent wire sections for active signals. For mid layers with slightly larger minimum spaces, the routine could avoid placing thermal tower features on tracks that would be at minimum spacing between two active signals. It could also avoid using adjacent tracks. For upper layers with sufficiently large minimum spacing constraints, the routine may allow all available metal tracks to be used without incurring significant cross capacitance penalties.

In some embodiments, additional factors such as design demands, e.g., certain regions with high power density and hotspots, may be taken into account and weighed against any adverse effects on neighboring signal lines.

It should be appreciated that any variety of rules could be employed here with various degrees of resolution, depending, among other things, on trade-offs between execution performance and inner operability with the other aspects of the routine.

At 706, the routine may build a position assemblage for approved candidate positions in the scan region. As used herein, a position assemblage refers to a stored data representation of adjacent approved candidate positions. (A position assemblage may also be referred to as a tower assemblage data structure.) Building such assemblages may involve examining neighboring positions (e.g., downward, upward or both, depending on where the routine started) to see if they satisfy candidate approval from 704. It does this until it runs into an unapproved position adjacent to a last approved position. Note that in this embodiment, it need not check laterally adjacent positions since it has done this and recorded them already at 704. However, it should be appreciated that other approaches could be employed. For example, the routine could simply check each position in each region, go to the next region, and then start over at the next level, recording each checked position as an approved or disapproved candidate. Of note, it has been appreciated that in some embodiments, an efficient way to create thermal towers is to operate by scanning regions of metal layers from a top layer downward, building thermal tower assemblage data structures as the routine proceeds downward, the data structures representing thermal tower assemblages that can then be manufactured in the metal layer assembly.

At 708, it checks to see if there are any remaining regions in the layer. If so, it goes to the next unscanned region and returns to 704 where it executes as already described. On the other hand, if it determines there are no remaining unscanned regions in the layer, then it goes to 710 and determines if there are any remaining unscanned layers. If so, it goes to the next layer, resets back to an initial region value, and returns to 704 to execute as already described.

On the other hand, if it determines there are no remaining unscanned layers at 710, then it completes this phase, having generated a database 712 of approved position assemblages. From here, at 716, the routine assigns (or defines) thermal tower configurations based on the approved position assemblages. It could assign tower configurations corresponding directly to the generated position assemblages, or it could combine, reduce or otherwise change the assemblages. It could step back and apply certain geometric shapes and/or patterns based on the sizes, locations, and quality of the approved position assemblages. For example, it may work to minimize the widths of the metal assemblages since such floating features should have small penalty impacts on cross-capacitance. To further minimize cross-capacitance penalties, the routine can be tuned to avoid problematic proximity to wires carrying critical or sensitive signals, depending on each layer's width and spacing constraints.

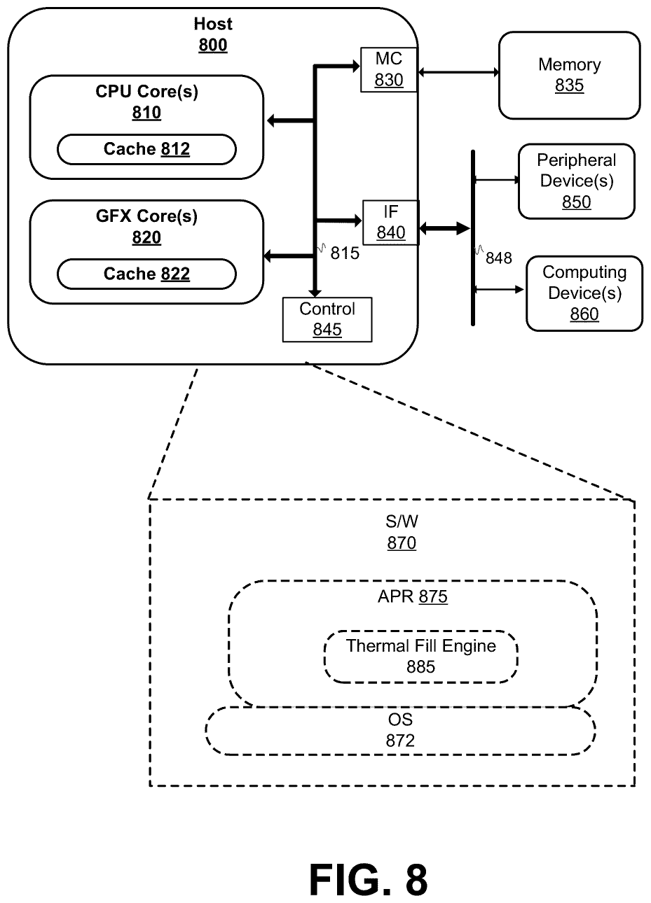

FIG. 8 is a block diagram showing a computing system that may be used for running some or all of the tools used for implementing a design flow as described in FIG. 6. The system generally includes a host processing device 800, which is coupled to external memory 835 and to peripheral devices 850, as well as to other computing devices 860 through interface 848. Interface 848 may be implemented with a combination of one or more point-to-point links, busses, or fabrics and may include multiple networks linking the host to the peripheral devices and to the other computing devices. The system also includes software 870, some or all of which may be stored and run within the depicted system.

The memory 835 may include any suitable memory such as DRAM and/or non-volatile memory systems such as memory servers, solid-state drives and portable memory such as flash drives. The peripheral devices 850 correspond to user interface devices such as displays, keyboards, headsets, and the like.

The host processing device 800 includes CPU cores 810 with associated cache 812, graphics processing cores 820 with their associated cache 822, a fabric interconnect system 815, memory controller 830, interface controller 840, and control/Memory block 845, which may encompass various different functional blocks such as low-level shared cache, security management, fabric control, power management, etc.

The software 870 includes an operating system 872 and an APR engine 875 for implementing placement and routing routines when the tool is executed. The APR tool 875 includes a thermal fill module 885 for implementing thermal tower configuration, placement, and routing operations, as discussed herein. Note that while thermal fill module 885 is shown as part of APR engine 875, it could alternatively operate as part of another tool or autonomously in cooperation with other EDA tools, outside of or wholly or partially from within the APR engine 875. The software 870 may be stored, when not running, wholly or partially, in external host memory 835 or across different storage devices capable of being linked with host 800. Similarly, when running, apart from the OS 872, some or all of the other components could be executed by the host processing device 800, itself, or together by host processing device 800 and other computing devices 860 in a distributed fashion and not necessarily at the same time.

The computing devices 860 include any suitable computing device that can operate apart from, in concert with, or in support of the host processing device 800. For example, a computing device could be a supporting device such as an accelerator, a co-processor, a GPU card, a special function module such as an FPGA or ASIC module designed for special-purpose processing such as network or AI processing. The computer devices can also include stand-alone devices such as mobile devices, personal computers, server systems, datacenter systems, and the like. It will be appreciated that with many IC design processes, many different design, modeling, simulation, and verification tools may be implemented in one, some or many different computing systems that may or may not be interconnected to one another. For example, it is typical for different design teams to work on their aspects of IC EDA and thus, they may use tools running in different computing systems at different times with files being shared, handed off, returned, modified, reviewed, further processed, etc. Accordingly, embodiments of the methods and physical features described herein may be implemented in many different ways using a variety of computing systems and disaggregated work-flow schemes and thus, the inventive embodiments are not limited to any particular scheme.

Illustrative examples of the technologies disclosed herein are provided below. An embodiment of the technologies may include any one or more, and any compatible combination of, the examples described below.

Example 1 is an apparatus that includes an integrated circuit having a metallization stack and a transistor layer comprising a plurality of operable transistors. The metallization stack includes a plurality of metal layers and a plurality of via layers that are interleaved within the plurality of metal layers. The metallization stack also has signal lines formed from wires from different metal layers coupled to one another through vias from different via layers, the signal lines being coupled to at least some of the operable transistors. The metallization stack also includes thermal tower assemblages formed from wires from different metal layers coupled to one another through vias from different via layers, whereby the thermal tower assemblages are not coupled to the operable transistors.

Example 2 includes the subject matter of example 1, and wherein the thermal tower assemblages are coupled to unused transistor material in the transistor layer through contacts. In some cases, they may be coupled to dummy transistors through gate contacts.

Example 3 includes the subject matter of any of examples 1 and 2, and wherein the metallization stack includes metal fill pieces disposed within two or more of the plurality of metal layers.

Example 4 includes the subject matter of any of examples 1-3, and wherein the thermal tower assemblages include a first set of assemblages having the same configurations and feature sizes and a second set of assemblages having different configurations from those of the first set.

Example 5 includes the subject matter of any of examples 1-4, and wherein the thermal tower assemblages include a first set of assemblages consisting of wires from two adjacent metal layers and a second set of assemblages consisting of wires from three adjacent metal layers.

Example 6 includes the subject matter of any of examples 1-5, and wherein the thermal tower assemblages include a third set of assemblages consisting of wires from three adjacent metal layers.

Example 7 includes the subject matter of any of examples 1-6, and wherein the metal layers include a local layer with wire sections disposed along spaced apart tracks, wherein thermal tower assemblages having a wire section in the local metal layer are at least two tracks away from a wire in that local metal layer of a signal line.

Example 8 includes the subject matter of any of examples 1-7, and wherein the metallization stack is a frontside metallization stack and the integrated circuit comprises a backside metallization stack having at least one metal layer to provide power to the operable transistors.

Example 9 includes the subject matter of any of examples 1-8, and wherein the transistor layer is coupled to the frontside metallization stack. In some cases, another aspect of this example may be to couple tower assemblages to backside assemblies, which may and/or may not couple (e.g., thermally, structurally) them to transistors, dummy or otherwise.

Example 10 is a thermal fill method that is to operate by scanning regions of metal layers from a top layer downward, building thermal tower assemblage data structures as it proceeds downward, the data structures representing thermal tower assemblages to be manufactured in the metal layer assembly.

Example 11 is a method for incorporating thermal tower assemblages into a metallization stack. The method includes operating a tool to place and route interconnect signal lines for the metallization stack and executing a thermal fill routine using signal interconnect data generated by the tool to identify and configure thermal tower assemblages to be disposed in the metallization stack within the interconnect signal lines.

Example 12 includes the subject matter of example 11, and further comprising executing a DFM fill routine after the interconnect signal lines have been placed and routed and after the thermal fill routine has executed to place metal pieces in metal layer areas having insufficiently low metal density.

Example 13 includes the subject matter of any of examples 11-12, and wherein executing the thermal fill routine includes identifying positions in metal layers of the metallization stack that are available to be used for thermal tower wire sections.

Example 14 includes the subject matter of any of examples 11-13, and wherein identifying includes examining each metal layer through separate scan regions.

Example 15 includes the subject matter of any of examples 11-14, and wherein the routine looks for available positions directly beneath or above an identified available position defining an available position column of contiguous available positions until it runs into an unavailable position.

Example 16 includes the subject matter of any of examples 11-15, and wherein the routine defines a tower configuration based on the available position column.

Example 17 includes the subject matter of any of examples 11-16, and wherein the routine defines some tower configurations by combining multiple available position columns.

Example 18 includes the subject matter of any of examples 11-17, and wherein identifying available positions includes determining if a position is occupied by or too close to a signal line feature.

Example 19 includes the subject matter of any of examples 11-18, and wherein determining if a position is too close to a signal line feature depends on the signal line feature's layer location.

Example 20 includes the subject matter of any of examples 11-19, and wherein determining if a position is too close to a signal line feature depends on whether the signal line feature is in a higher priority heat transfer region.

Example 21 is a computer readable storage medium having instructions that when executed perform the thermal fill routine in accordance with the subject matter of any of examples 11-20.

Example 22 is a computer system that includes a host processor and memory. The host processor is to execute or administer the execution of placement and routing tools for generating signal line and thermal tower assemblage placement and routing data for signal lines and thermal tower assemblages to be manufactured in an integrated circuit metal layer assembly. The memory has instructions that when executed by the host processor, cause the signal line and thermal tower assemblage placement and routing data to be generated.

Example 23 includes the subject matter of example 22, and wherein the instructions include instructions for a signal interconnect APR (automatic placement and routing) tool to generate the signal line placement and routing data.

Example 24 includes the subject matter of any of examples 22-23, and wherein the instructions include instructions for a thermal fill routine that is to be executed after the signal interconnect APR tool generates the signal line placement and routing data.

Example 25 includes the subject matter of any of examples 22-24, and wherein the thermal fill routine instructions when executing identify positions in metal layers of the metal layer assembly that are available to be used for thermal tower wire sections.

Example 26 includes the subject matter of any of examples 22-25, and wherein the thermal fill routine instructions when executing examine each metal layer through separate scan regions.

Example 27 includes the subject matter of any of examples 22-26, and the thermal fill routine instructions when executing look for available positions directly beneath or above an identified available position defining an available position column of contiguous available positions until it runs into an unavailable position.

Example 28 includes the subject matter of any of examples 22-27, and the thermal fill routine instructions when executing define a tower configuration based on the available position column.

Example 29 includes the subject matter of any of examples 22-28, and wherein the thermal fill routine instructions when executing define some tower configurations by combining multiple available position columns.

Example 30 is a computer readable storage medium having instructions that when executed perform a method for incorporating thermal tower assemblages into a metallization stack. The method includes executing a thermal fill routine using signal interconnect data generated by a signal interconnect placement and routing tool to identify and configure thermal tower assemblages to be disposed in the metallization stack among the interconnect signal lines.

Example 31 includes the subject matter of example 30, and wherein executing the thermal fill routine includes identifying positions in metal layers of the metallization stack that are available to be used for thermal tower wire sections.

Example 32 includes the subject matter of any of examples 30-31, and wherein identifying includes examining each metal layer through separate scan regions.

Example 33 includes the subject matter of any of examples 30-32, and wherein the executing method looks for available positions directly beneath or above an identified available position to define an available position column of contiguous available positions until it runs into an unavailable position.

Example 34 includes the subject matter of any of examples 30-33, and wherein the method defines a tower configuration based on the available position column.

Example 35 includes the subject matter of any of examples 30-34, and wherein the executing method defines some tower configurations by combining multiple available position columns.

Example 36 includes the subject matter of any of examples 30-35, and wherein identifying available positions includes determining if a position is occupied by or too close to a signal line feature.

Example 37 includes the subject matter of any of examples 30-36, and wherein determining if a position is too close to a signal line feature depends on the signal line feature's layer location.

Example 38 includes the subject matter of any of examples 30-37, and wherein determining if a position is too close to a signal line feature depends on whether the signal line feature is in a higher priority heat transfer region.

As used in this specification, the term “embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function.

Different circuits or modules may share or even consist of common components. for example, A controller circuit may be a circuit to perform a first function and at the same time, the same controller circuit may also be a circuit to perform another function, related or not related to the first function.

The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

A circuit design processed as described herein may be implemented within an IC. In one or more embodiments, the circuit design may be processed by a system to generate a configuration bitstream that may be loaded into an IC to physically implement the circuitry described by the processed circuit design within the IC.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “output” means storing in physical memory elements, e.g., devices, writing to display or other peripheral output device, sending or transmitting to another system, exporting, or the like.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth.

A computer program product may include a computer readable storage medium (or media) having computer readable program instructions thereon for causing a processor to carry out aspects of the inventive arrangements described herein. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object oriented programming language and/or procedural programming languages. Computer readable program instructions may include state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

What is claimed is:

1. An integrated circuit apparatus comprising:
a transistor layer comprising a plurality of operable transistors; and
a metallization stack including:
a plurality of metal layers and a plurality of via layers interleaved within the plurality of metal layers; and
signal lines formed from wires from different metal layers coupled to one another through vias from different via layers, the signal lines being coupled to at least some of the operable transistors; and
thermal tower assemblages formed from wires from different metal layers coupled to one another through vias from different via layers, the thermal tower assemblages not being coupled to the operable transistors.

2. The apparatus of claim 1, wherein the thermal tower assemblages are coupled through contacts to unused transistor material in the transistor layer.

3. The apparatus of claim 1, wherein the metallization stack includes metal fill pieces disposed within two or more of the plurality of metal layers.

4. The apparatus of claim 1, wherein the thermal tower assemblages include a first set of assemblages having the same configurations and feature sizes and a second set of assemblages having different configurations from those of the first set.

5. The apparatus of claim 1, wherein the thermal tower assemblages include a first set of assemblages consisting of wires from two adjacent metal layers and a second set of assemblages consisting of wires from three adjacent metal layers.

6. The apparatus of claim 5, wherein the thermal tower assemblages include a third set of assemblages consisting of wires from three adjacent metal layers.

7. The apparatus of claim 1, wherein the metal layers include a local layer with wire sections disposed along spaced apart tracks, wherein thermal tower assemblages having a wire section in the local metal layer are at least two tracks away from a wire in that local metal layer of a signal line.

8. The apparatus of claim 1, wherein the metallization stack is a frontside metallization stack and the integrated circuit comprises a backside metallization stack having at least one metal layer to provide power to the operable transistors.

9. The apparatus of claim 8, wherein the transistor layer is coupled to the frontside metallization stack.

10. A method for incorporating thermal tower assemblages into a metallization stack, comprising:
operating a tool to place and route interconnect signal lines for the metallization stack; and
executing a thermal fill routine using signal interconnect data generated by the tool to identify and configure thermal tower assemblages to be disposed in the metallization stack within the interconnect signal lines.

11. The method of claim 10, further comprising executing a DFM fill routine after the interconnect signal lines have been placed and routed and after the thermal fill routine has executed to place metal pieces in metal layer areas having insufficiently low metal density.

12. The method of claim 10, wherein executing the thermal fill routine includes identifying positions in metal layers of the metallization stack that are available to be used for thermal tower wire sections.

13. The method of claim 12, wherein identifying includes examining each metal layer through separate scan regions.

14. The method of claim 13, wherein the routine looks for available positions directly beneath or above an identified available position defining an available position column of contiguous available positions until it runs into an unavailable position.

15. The method of claim 14, wherein the routine defines a tower configuration based on the available position column.

16. The method of claim 15, wherein the routine defines some tower configurations by combining multiple available position columns.

17. A computer system, comprising:
a host processor to execute or administer the execution of placement and routing tools for generating signal line and thermal tower assemblage placement and routing data for signal lines and thermal tower assemblages to be manufactured in an integrated circuit metal layer assembly; and
memory having instructions that when executed by the host processor, cause the signal line and thermal tower assemblage placement and routing data to be generated.

18. The computer system of claim 17, wherein the instructions include instructions for a signal interconnect APR (automatic placement and routing) tool to generate the signal line placement and routing data.

19. The computer system of claim 18, wherein the instructions include instructions for a thermal fill routine that is to be executed after the signal interconnect APR tool generates the signal line placement and routing data.

20. The computer system of claim 19, wherein the thermal fill routine is to operate by scanning regions of metal layers from a top layer downward, building thermal tower assemblage data structures representing thermal tower assemblages to be manufactured in the metal layer assembly.
